(19) United States
(12) Patent Application Publication
(10) Pub. No.: US 2008/0004175 A1
(43) Pub. Date: Jan. 3, 2008

(54) PHOTOCATALYST FILM AND METHOD FOR MANUFACTURING THE SAME

(75) Inventors: Toshihide AOSHIMA, Shizuoka-ken (JP); Koichi KAWAMURA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/769,761

(22) Filed: Jun. 28, 2007

(30) Foreign Application Priority Data
Jun. 30, 2006 (JP) 2006-182288

(51) Int. Cl. B01J 31/00

(52) U.S. Cl. 502/159

(57) ABSTRACT

The present invention provides a photocatalyst film that includes a support; an organic-inorganic composite layer containing, in a graft polymer layer including a graft polymer chain directly bonded to the surface of the support, a crosslinked structure formed by hydrolysis and condensation polymerization of an alkoxide of an element selected from Si, Ti, Zr or Al; and a photocatalytically active layer, in this order, and a method for producing the same.

### CROSS-REFERENCE TO RELATED APPLICATION

This application claims priority under 35 USC 119 from Japanese Patent Application No. 2006-182288, the disclosure of which is incorporated by reference herein.

### BACKGROUND OF THE INVENTION

1. Field of the Invention

The present invention relates to a photocatalyst film and a method for manufacturing the same. In particular, the invention relates to a photocatalyst film having high adhesiveness between a photocatalytically active layer and a support and being excellent in durability against deterioration caused by a photocatalytic action and persistency of durability, and to a method for manufacturing the same.

2. Description of the Related Art

A photocatalyst film comprising a photocatalytically active layer composed of a photocatalytically active material (which may be simply referred to as a photocatalyst hereinafter) provided on an organic support such as a plastic has been proposed (for example, see Japanese Patent Application Laid-Open (JP-A) Nos. 11-91030 and 2001-277418).

The photocatalyst generates electrons excited in a conduction band by being excited when it is irradiated with a light having an energy larger than a band gap, and holes are formed in a valence band. The generated electrons form superoxide anions (O²⁻) by reducing surface oxygen while the holes form hydroxide radicals (OH) by oxidation of surface hydroxyl groups. These reactive active species of oxygen have been known to decompose organic substances adhered on the surface of the photocatalyst with high efficiency by exhibiting a strong oxidative decomposition function. Another known function of the photocatalyst is that the surface of the photocatalyst expresses super-hydrophilicity in which a contact angle with water becomes 10 degrees or less when the photocatalyst is excited with light. Accordingly, the photocatalyst film having these functions has been expected to be applicable to many uses.

However, it has been a problem that the organic support is deteriorated in a short period of time by a photocatalytic action when the photocatalytically active layer is directly formed on the organic support. In view of such a problem, an intermediate layer is usually provided between the organic support and the photocatalytically active layer in order to protect the organic support from being deteriorated by the photocatalytic action and in order to improve adhesiveness between the photocatalytically active layer and the organic layer. An organic layer made of a silicone resin or an acryl-modified silicone resin with a thickness of several μm has been usually used for the intermediate layer.

However, the photocatalyst film having the above-mentioned intermediate layer also involves problems in that the film is deteriorated within about 1 to 3 years to cause a decrease in transparency due to interference of the film when the film is desired to be transparent or a decrease in desired functions such as anti-contamination. The causes of such deterioration is decomposition of organic components due to the photocatalytic action since the intermediate layer contains organic components, which consequently generates cracks in the intermediate layer, or swelling and partial peeling at the interface between the photocatalytically active layer and the intermediate layer or between the intermediate layer and the organic support, which generate interference. There is another problem in that partial peeling and cracks are liable to occur due to warping and bending of the film itself when the photocatalyst film has the intermediate layer with a thickness of several μm.

A photocatalyst film having an organic-inorganic composite gradient film in which the composition continuously changes in the direction of thickness has been proposed as one photocatalyst film for improving the problems that occur when the film has the above-mentioned intermediate layer (see JP-A No. 2003-41034). This organic-inorganic composite gradient film is an organic-inorganic composite film containing chemical compounds between an organic polymer and a metallic compound, and has a component gradient structure in which the content of the metallic compound continuously changes in the direction of thickness of the film. Although adhesiveness between the support and the photocatalytically active layer is improved, further improvement of the photocatalyst film having such an organic-inorganic composite gradient film are desired since durability against deterioration caused by the photocatalytic action and persistency of durability are insufficient. However, at present, no satisfactory photocatalyst film has been provided today.

### SUMMARY OF THE INVENTION

The present invention has been made in view of the circumstances described above. A first aspect of the invention is to provide a photocatalyst film comprising, in the following order: a support; an organic-inorganic composite layer containing, in a graft polymer layer comprising a graft polymer chain directly bonded to the surface of the support, a crosslinked structure formed by hydrolysis and condensation polymerization of an alkoxide of an element selected from the group consisting of Si, Ti, Zr and Al; and a photocatalytically active layer.

A second aspect of the invention is to provide a method for manufacturing a photocatalyst film comprising: forming a graft polymer layer comprising a graft polymer chain by forming the graft polymer chain directly bonded to the surface of a support; forming an organic-inorganic composite layer by a crosslinking reaction including hydrolysis and condensation polymerization of an alkoxide of an element selected from the group consisting of Si, Ti, Zr and Al in the graft polymer layer; and forming a photocatalytically active layer on the organic-inorganic composite layer.

### DETAILED DESCRIPTION OF THE INVENTION

The present invention will be described in detail below. The phrase “from . . . to . . . ” in the specification denotes a range in which numerical values described after “from” and “to” are included as the minimum and maximum values, respectively.

The photocatalyst film of the invention comprises, in the following order: a support; an organic-inorganic composite layer containing, in a graft polymer layer comprising a graft polymer chain directly bonded to the surface of the support, a crosslinked structure formed by hydrolysis and condensation polymerization of an alkoxide of an element selected from the group consisting of Si, Ti, Zr and Al; and a photocatalytically active layer.

The phrase “comprise in the following order” refers to providing the organic-inorganic composite layer and the photocatalytically active layer in this order on the support, and the presence of optionally provided arbitrary layers other than the above-mentioned layers is by no means denied.

The graft polymer chain is preferably formed by a polymerization reaction using initiator species generated on the surface of the support as initiation points. The graft polymer chain preferably has an alkoxide group of an element selected from the group consisting of Si, Ti, Zr and Al and/or an amide group in the chain thereof. More preferably, the graft polymer chain is a copolymer having a structural unit having a polar group, which is preferably an amide group, and a structural unit having an alkoxide group of an element selected from the group consisting of Si, Ti, Zr and Al.

The crosslinked structure is preferably formed in the organic-inorganic composite layer of the invention using an alkoxide of Si in terms of reactivity and easy acquisition of the compound.

The crosslinked structure formed by hydrolysis and condensation polymerization of the alkoxide as described above is appropriately referred to as a “sol-gel crosslinked structure” hereinafter.

While the operation of the invention is not clear, it is presumed to be as follows. The organic-inorganic composite layer of the invention is a layer containing a graft polymer chain (an organic component) formed by being directly bonded to the surface of the support and a crosslinked structure (an inorganic component) formed by hydrolysis and condensation polymerization of an alkoxide of the element selected from the group consisting of Si, Ti, Zr and Al in the graft polymer layer comprising the graft polymer chain.

Such an organic-inorganic composite layer has high adhesiveness to the support, and wear resistance is enhanced with high durability even when the layer is a thin layer. When the graft polymer chain has polar groups, in particular, a polar interaction arises between the crosslinked structures by the action of the polar groups, and an organic-inorganic composite layer excellent in strength and durability may be formed. When the graft polymer chain has an alkoxide group of the element selected from the group consisting of Si, Ti, Zr and Al (hereinafter, sometimes referred to as a “specific alkoxide group”) in the chain, covalent bonds are formed between the graft polymer chain and the crosslinked structure, and strength and durability of the organic-inorganic composite layer are improved. In addition, since the inorganic component on the surface of the organic-inorganic composite layer and the photocatalytically active layer form a covalent bond by a condensation reaction, adhesiveness between the photocatalytically active layer and the organic-inorganic composite layer becomes excellent.

Since organic materials are usually favorably used as the material of the support in a photocatalyst film, degradation of the material caused by photocatalytic action is inevitable. However, the photocatalyst film of the invention is able to exhibit an excellent effect for suppressing degradation caused by the photocatalytic action even when a support made of an organic material is used by providing the organic-inorganic composite layer comprising the inorganic component between the support and the photocatalytically active layer.

Consequently, the photocatalyst film of the invention is excellent in both adhesiveness between the photocatalytically active layer and the support and in suppressing of the degradation of the support cased by the photocatalytic action, and these effects can be sustained for a long time.

Since the organic-inorganic composite layer of the invention can be formed thinner than the thickness of the intermediate layer (on the order of several μm) of the photocatalyst film of the related art, the photocatalyst film becomes excellent in bendability when a flexible support is used.

The photocatalyst film of the invention may be manufactured according to the method for manufacturing a photocatalyst film of the invention. Preferably, the method for manufacturing the photocatalyst film of the invention comprises: forming a graft polymer layer comprising a graft polymer chain by forming the graft polymer chain directly bonded to the surface of the support (appropriately referred to as a “process for forming a graft polymer layer” hereinafter); forming an organic-inorganic composite layer by a crosslinking reaction by hydrolysis and condensation polymerization of an alkoxide of an element selected from the group consisting of Si, Ti, Zr and Al (appropriately referred to as a “process for forming an organic-inorganic composite layer” hereinafter); and forming a photocatalytically active layer on the organic-inorganic composite layer (appropriately referred to as a “process for forming a photocatalytically active layer” hereinafter).

The process for forming the graft polymer layer, the process for forming the organic-inorganic composite layer, and the process for forming the photocatalytically active layer will be described in this order below.

### The Process for Forming the Graft Polymer Layer

In this process, the graft polymer layer including the graft polymer chain is formed by forming the graft polymer chain directly bonded to the surface of a support.

The “surface of the support” as used in the invention refers to a surface on which the graft polymer of the invention is able to chemically bond to the surface. The surface refers to the support's own surface as well as the surface of an intermediate layer formed on the support when an intermediate layer such as a polymerization initiating layer is provided on the surface as will be described later.

The methods for forming the graft polymer chain directly bonded to the surface of the support include: (1) a method for forming the graft polymer chain by allowing a compound having a polymerizable double bond to polymerize by a surface graft polymerization on the support as a initiation point (hereinafter, sometimes referred to as “method (1)”), and (2) a method for forming the graft polymer chain by a chemical reaction between a polymer having functional groups reactive to the support and the surface of the support (hereinafter, sometimes referred to as “method (2)”). The two methods will be described below.

Method (1) is generally called as a surface graft polymerization method. In the surface graft polymerization method, active species are formed on the surface of the support by plasma irradiation, light irradiation or heating, and a compound having polymerizable double bonds disposed so as to be in contact with the support is polymerized using the active species as initiating points. The terminal of the graft polymer chain formed is directly bonded and fixed to the surface of the support according to method (1).

Any known methods described in the references may be used for the surface graft polymerization method for implementing the invention. For example, photo-graft polymerization methods and plasma irradiation graft polymerization methods are described in Shin-Kohbunshi Jikken Gaku (Experimental Polymer Science, Revised Edition), Vol. 10, p 135, edited by The Society of Polymer Science, Japan, 1994, published by Kyoritsu Shuppan Co. Graft polymerization methods by irradiating a radiation such as γ-ray or electron beam are described in Handbook of Adsorption Technology, p 203 and p 695, supervised by Takeuchi, published by NTS Co., February, 1999. Specific examples of the photo-graft polymerization method available are described in JP-ANos. 63-92658, 10-296895 and 11-119413. Examples of the plasma irradiation graft polymerization method and radiation graft polymerization method are described in the above-cited references and in Macromolecules, Vol. 19, Ikada et al., p 1804, 1986.

Specifically, the graft polymer chain may be formed by allowing radicals as active species to be generated on the surface by plasma or electron beam treatment, and by allowing the surface of the support having the active species to react with a compound (for example a monomer) having polymerizable double bonds thereafter.

The photopolymerization-graft polymerization method may be implemented by coating the surface of the film support with a photopolymerizable compound followed by irradiating a light to the surface in contact with a radical polymerizable compound as described in the above-cited references as well as in JP-ANos. 53-17407 (Kansai Paint Co.) and 2000-212313 (Dainippon Ink & Chemicals, Inc.).

Compounds useful for forming the graft polymer chain according to method (1) is required to have polymerizable double bonds. The compound preferably has the polymerizable double bond as well as polar groups in terms of an ability for forming polar interaction with the sol-gel cross linked structure formed in the process for forming the organic-inorganic composite layer to be described later. Further preferably, the compound has a polymerizable double bond as well as a specific alkoxide group in terms of covalent bonds formed between the compound and the sol-gel cross linked structure formed in the process for forming the organic-inorganic composite layer to be described later.

Any compounds including polymers, oligomers and monomers may be used as the compound applicable to method (2), so long as the compound that has a double bond in the molecule and a polar group and/or a specific alkoxide group as needed.

One of the useful compounds of the invention is a monomer having polar groups. While examples of the monomer having the polar group useful in the invention include monomers having positive charges such as ammonium and phosphonium groups and monomers having negative charges or acidic groups capable of dissociating into negative charges such as a sulfonic acid group, a carboxyl group, a phosphoric acid group and a phosphonic acid group, other examples available include monomers having polar groups having nonionic groups such as a hydroxyl group, an amide group, a sulfonamide group, an alkoxy group and a cyano group.

Specific examples of the monomer having the polar group particularly useful in the invention are as follows: (meth)acrylic acid or alkali metal salts and amine salts thereof; itaconic acid or alkali metal salts and amine salts thereof, allylamine or hydrogen halides thereof; 3-vinyl propionic acid or alkali metal salts and amine salts thereof, vinylsulfonic acid or alkali metal salts and amine salts thereof, styrene sulfonic acid or alkali metal salts and amine salts thereof, 2-sulfoethylene (meth)acrylate, 3-sulfopropylene (meth)acrylate or alkali metal salts and amine salts thereof, 2-acrylaminde-2-methylpropane sulfonic acid or alkali metal salts and amine salts thereof, acid phosphoxypolyoxyethyleneglycol mono(meth)acrylate or salts thereof, 2-dimethylaminoethyl (meth)acrylate or hydrogen halide thereof, 3-trimethylammoniumpropyl (meth)acrylate; 3-trimethylammoniumpropyl (meth)acrylamide; and N,N,N-trimethyl-N-(2-hydroxy-3-methacryloyloxypropyl)ammonium chloride. 2-hydroxyethyl (meth)acrylate, (meth)acrylamide, N-monomethylol (meth)acrylamide, N-dimethylol (meth)acrylamide, N-vinyl pyrrolidone, N-vinyl acetamide and polyoxyethyleneglycol mono(meth)acrylate are also useful.

Macromers having polar groups useful in the invention may be obtained by the synthetic method described in Shin Kohbunshi Jikken Gaku (Experimental Polymer Scicence, Revised Edition), Vol. 2, Synthesis and Reaction of Polymers, edited by The Society of Polymer Science, Japan, 1995, published by Kyoritsu Shuppan Co. The macromers are also described in detail in Chemistry and Industry of Macro-monomers, Isamu Yamashita, published by IPC Co., 1989. Specifically, the macromer having a polar group may be synthesized according to the methods described in the above-mentioned references using the monomers having polar groups specifically described above such as acrylic acid, acrylamide, 2-acrylamide-2-methylpropane sulfonic acid and N-vinyl acetamide.

Examples of the particularly useful macromers of the macromers having polar groups used in the invention include: macromers derived from carboxylic group-containing monomers such as acrylic acid and methacrylic acid; sulfonic acid-base macromers derived from 2-acrylamide-2-methylpropane sulfonic acid, styrene sulfonic acid and salts thereof; amide-base macromers such as acrylamide and methacrylamide; amide-base macromers derived from N-vinylcarboxylic acid amide monomers such as N-vinyl acetamide and N-vinyl formamide; macromers derived from hydroxyl group-containing monomers such as hydroxyethyl methacrylate, hydroxyethyl acrylate and glycerol monomethacrylate; and macromers derived from alkoxy group- or ethyleneoxide group-containing monomers such as methoxyethyl acrylate, methoxypolyethyleneglycol acrylate and polyethyleneglycol acrylate. Monomers having a polyethyleneglycol chain or polypropyleneglycol chain may be also useful as the macromers of the invention. Macromers having amide groups as the polar groups are preferably used among the above-mentioned macromers in terms of strong polar interaction with the sol-gel crosslinked structure formed in the process for forming the organic-inorganic composite layer to be described later.

These macromers have a useful molecular weight in the range of from 400 to 100,000, preferably from 1000 to 50,000, and particularly from 1500 to 20,000.

The graft polymer chain according to the invention preferably has a specific alkoxide group in the chain as described previously. The specific alkoxide group is a substituent capable of forming a covalent bond through hydrolysis and condensation polymerization with a crosslinking agent (metal alkoxide) to be described later. A covalent bond may be formed between the sol-gel crosslinked structure formed in the process for forming the organic-inorganic composite layer to be described later and the graft polymer chain by allowing the graft polymer chain to have the specific alkoxide group.

Monomers and macromers having the specific alkoxide group is preferably used when the surface graft polymerization method of method (1) is used. A silane coupling group will be described as a representative example of the specific alkoxide group. An example of the silane coupling group suitable in the invention is a functional group represented by the following formula (I).

(R¹)ₘ(OR²)₃₋ₘ—Si— (I)

In formula (I), R¹ and R² each independently represent a hydrogen atom or a hydrocarbon group having 8 carbon atoms or less; and m represents an integer of from 0 to 2.

Examples of the hydrocarbon groups represented by R¹ and R² preferably include an alkyl group and an aryl group, more preferably a linear or cyclic alkyl group having 8 carbon atoms or less. Specific examples thereof include methyl group, ethyl group, propyl group, butyl group, pentyl group, hexyl group, heptyl group, octyl group, isopropyl group, isobutyl group, s-butyl group, t-butyl group, isopentyl group, neopentyl group, 1-methylbutyl group, isohexyl group, 2-ethylhexyl group, 2-methylhexyl group and cyclopentyl group.

R¹ and R² are preferably hydrogen atoms, methyl groups or ethyl groups in terms of the effect and readiness of acquisition.

Examples of the monomer having the functional group represented by formula (I) include (3-acryloxypropyl)trimethoxysilane, (3-acryloxypropyl)dimethylmethoxysilane, (3-acryloxypropyl)methyldimethoxysilane, (methacryloxymethyl)dimethylethoxysilane, (methacryloxymethyl)triethoxysilane, (methacryloxymethyl)trimethoxysilane, (methacryloxypropyl)dimethylethoxysilane, (methacryloxypropyl)dimethylmethoxysilane, (methacryloxypropyl)methyldiethoxysilane, (methacryloxypropyl)triethoxysilane, (methacryloxypropyl)triisopropylsilane and methacryloxypropyl(trismethoxyethoxy)silane.

When method (1) is used in the invention, the monomer or macromer having a polar group are preferably copolymerized with the monomer or macromer having a specific alkoxide group such as a silane coupling group by the surface graft polymerization method to form a graft polymer chain. The monomer or macromer having the amide group as the polar group is more preferably used among the above-mentioned monomers and macromers.

In method (2), the graft polymer chain may be formed by using a polymer having a functional group reactive to the support at the terminal of the main chain or at the side chain, and by permitting the functional group to react with the functional group on the surface of the support. While the functional group reactive to the support is not particularly restricted so long as the functional group is reactive to the functional group on the surface of the support, examples thereof include a silane coupling group such as an alkoxysilane, an isocyanate group, an amino group, a hydroxyl group, a carboxyl group, a sulfonic acid group, a phosphoric acid group, an epoxy group, an allyl group, a methacryloyl group and an acryloyl group.

Particularly useful compounds as the polymers having functional groups reactive to the support at the terminal of the main chain or at the side chain are polymers having a trialkoxysilyl group at the polymer terminal, polymers having an amino group at the polymer terminal, polymers having a carboxyl group at the polymer terminal, polymers having an epoxy group at the polymer terminal and polymers having an isocyanate group at the polymer terminal.

The polymer used herein preferably have a polar group, and examples of the polymer having the polar group include polyacrylic acid, polymethacrylic acid, polystyrene sulfonic acid, poly-2-acrylamide-2-methylpropane sulfonic acid and salts thereof, polyacrylamide and polyvinyl acetamide. Polymers of the monomers having the polar group used in method (1), or copolymers containing the monomers having the polar group may be also used other than those described above.

The polymer having an amide group as the polar group may be preferably used in terms of strong polar interaction with the sol-gel crosslinked structure formed in the process for forming the organic-inorganic composite layer.

Preferably, the polymer having the functional group reactive to the terminal of the main chain or to the side chain further has an alkoxide group of the element selected from the group consisting of Si, Ti, Zr and Al (specific alkoxide group). Using such polymer permits the specific alkoxide group to be introduced into the graft polymer chain formed. A covalent bond is formed between the sol-gel crosslinked structure formed in the process for forming the organic-inorganic composite layer to be described later and the graft polymer chain when the graft polymer chain contains the specific alkoxide group. It is particularly preferable in the invention that the polymer having the functional group reactive to the support at the terminal of the main chain or at the side chain has both the amide group as the polar group and the specific alkoxide group.

The graft polymer chain formed by the above-mentioned method preferably has the amide group and/or the specific alkoxide group in the invention in terms of the ability for forming polar interaction with the sol-gel crosslinked structure and the ability for forming the covalent bond.

The amount of introduction of the amide group in the graft polymer chain of the invention is preferably in a range of from 10 to 90 mol %, and the amount of introduction of the specific alkoxide group is also preferably in a range of from 10 to 90 mol %.

While the graft polymer chain of the invention preferably has the polar group and the specific alkoxide group in the chain thereof, a crosslinked structure between the graft polymer chains may be formed by introducing cross-linkable groups and polymerizable groups other than the groups described above. The crosslinked structure may be formed using these groups.

While any supports are available so long as they have enough mechanical strength and dimensional stability, a transparent film is preferably used when the photocatalyst film is required to be transparent.

Because the photocatalytically active layer is provided in the photocatalyst film of the invention, deterioration of the support caused by photocatalytic action of the photocatalytically active layer can be effectively suppressed even when a film made of an organic material is used as the support.

Specific examples of the film used for the support include polyester films such as polyethylene terephthalate film, polyethylene terephthalate-base polyester copolymer and polyethylene naphthalate film; polyamide films such as nylon 66 film, nylon 6 film and metaxylidene diamine polyamide copolymer film; polyolefin films such as polypropylene film, polyethylene film and ethylene-propylene copolymer film; polyimide films; polyamideimide films; polyvinyl alcohol films; ethylene-vinyl alcohol copolymer films; polyphenylene films; polysulfone films; and polyphenylene sulfide films. Polyester films such as polyethylene terephthalate, and polyolefin films such as polyethylene film and polypropylene film are preferable among them in terms of cost performance and transparency. These films may be stretched or non-stretched, and may be used alone or films having different properties may be used as a laminate.

The film used as the support in the invention preferably has a strength reduction ratio of 50% or less by a tensile test according to JIS C231 (edition in 2005) when an accelerated weathering test is applied to a film with a thickness of 50 μm using a carbon-arc sunshine weather meter.

Various additives and stabilizer may be added to or coated on the film used for the support so long as the effect of the invention is not impaired. Examples of the additive available include an antioxidant, an antistatic agent, a lubricant, a heat stabilizer and a weathering agent. These additives may be appropriately selected and used. The weathering agent is favorably used as the additive in terms of suppression of deterioration of the support caused by photocatalytic action.

Examples of the weathering agent include a UV-absorbing agent, a photostabilizer and a UV-scattering agent. The UV-absorbing agent absorbs high energy UV light and converts it into low energy in order to suppress generating of radical and protect the support made of a plastic film from being deteriorated. The photostabilizer inhibits chain reactions caused by coupling of the polymer chain with radicals generated by UV light, and inhibits the support made of a plastic film from being deteriorated. The UV-scattering agent gives a UV-shielding effect by scattering UV light.

The UV-absorbing agent may be roughly divided into salicylate-base, benzophenone-base, benzotriazole-base and substituted acrylonitrile-base UV-absorbing agents, and other UV-absorbing agents. Examples of the salicylate-base UV-absorbing agent include phenyl salicylate, p-octylphnenyl salicylate and p-t-butylphenyl salicylate. Examples of the benzophenone-base UV-absorbing agent include 2,2′-dihydroxy-4-methoxy benzophenone, 2,2′-dihydroxy-4,4′-dimethoxy benzophenone, 2,2′,4,4′-tetrahydroxy benzophenone, 2-hydroxy-4-methoxy benzophenone, 2,4-dihydroxy benzophenone and 2-hydroxy-4-octoxy benzophenone.

Examples of the benzotriazole-base UV-absorbing agents include
2-(2-hydroxy-3′,5′-di-tert-butylphenyl)-5-chlorobenzotriazole,
2-(2′-hydroxy-3′-tert-butyl-5′-methylphenyl)-5-chlorobenzotriazole,
2-(2′-hydroxy-3′-tert-amyl-5′-isobutylphenyl)-5-chlorobenzotriazole,
2-(2′-hydroxy-3′-isobutyl-5′-methylphenyl)-5-chlorobenzotriazole,
2-(2′-hydroxy-3′-isobutyl-5′-propylphenyl)-5-chlorobenzotriazole,
2-(2′-hydroxy-3′,5′-di-tert-butylphenyl)benzotriazole,
2-(2′-hydroxy-5′-methylphenyl)benzotriazole and
2-[2′-hydroxy-5′-(1,1,3,3-tetramethyl)phenyl]benzotriazole.

Examples of the substituted acrylonitrile-base UV-absorbing agent include ethyl 2-cyano-3,3-diphenylacrylate and 2-ethylhexyl 2-cyano-3,3-diphenylacrylate.

Examples of other UV-absorbing agents include resorcinol monobenzoate, 2,4-di-t-butylphenyl-3,5-di-t-butyl-4-hydroxybenzoate and N-(2-ethylphenyl)-N′-(2-ethoxy-5-t-butylphenyl)oxalic acid diamide.

One of these UV-absorbing agents may be used alone, or a plurality of them may be used in combination.

As the photostabilizers, hindered amine-base photostabilizers are preferable, and examples of them include bis(2,2,6,6-tetramethyl-4-piperidyl)sebacate, condensation polymerization product of succinic acid and dimethyl-1-(2-hydroxyethyl)-4-hydroxy-2,2,6,6-tetramethyl piperidine, poly[6-(1,1,3,3-tetramethylbutyl)imino-1,3,5-triazine-2,4-diyl][(2,2,6,6-tetramethyl-4-piperid yl)imino]-hexamethylene[(2,2,6,6-tetramethyl-4-piperidyl)imide], tetrakis(2,2,6,6-tetramethyl-4-piperidyl)-1,2,3,4-butane tetracarboxylate, 2,2,6,6-tetramethyl-4-piperidyl benzoate, bis(1,2,6,6-pentamethyl-4-piperidyl)-2-(3,5-di-t-butyl-4-hydroxybenzyl)-2-n-butyl malonate, bis-(N-methyl-2,2,6,6-tetramethyl-4-piperidyl)sebacate, 1.1′-(1,2-ethanediyl)bis(3,3,5,5-tetramethylpiperazine), (mixed 2,2,6,6-tetramethyl-4-piperizyl/tridecyl)-1,2,3,4-butane tetracarboxylate, (mixed 1,2,2,6,6-pentamethyl-4-piperizyl/tridecyl)-1,2,3,4-butane tetracarboxylate, mixed [2,2,6,6-tetramethyl-4-piperizyl/β, β, β′, β′-tetramethyl-3,9-[2,4,8,10-tetraoxaspiro(5,5)undecan e]diethyl]-1,2,3,4-butane tetracarboxylate, mixed[1,2,2,6,6-pentamethyl-4-piperizyl/β, β, β′, β, β′-tetramethyl-3,9-[2,4,8,10-tetraoxaspiro(5,5)unde cane]diethyl]-1,2,3,4-butane tetracarboxylate, condensation product of N,N′-bis(3-aminopropyl)ethylenediamine-2,4-bis[N-butyl-N-(1,2,2,6,6-pentamethyl-4-piperid yl)amino]-6-chloro-1,3,5-triazine, poly[6-N-morphoryl-1,3,5-triazine-2,4-diyl][(2,2,6,6-tetramethyl-4-piperidyl)imino]hexameth ylene[(2,2,6,6-tetramethyl-4-piperidyl)imide], condensation product of N,N′-bis(2,2,6,6-tetramethyl-4-piperidyl)hexamethylene diamine and 1,2-dibromoethane, and [N-(2,2,6,6-tetramethyl-4-piperidyl)-2-methyl-2-(2,2,6,6-tetramethyl-4-piperidyl)imino]propi onamide.

One of the photostabilizers may be used alone, or a plurality of them may be used in combination. The photostabilizer and the UV-absorbing agent may be used together.

Commercially available products may be used for the support containing the weathering agent, and examples of them include Tetron HB (trade name) manufactured by DuPont film Co. and T-UV (trade name) manufactured by Tochisen Co.

The support may be subjected to surface treatments such as a corona treatment, a plasma treatment, a glow discharge treatment, an ion bombard treatment, chemical treatment, solvent treatment and surface roughening treatment.

The film used for the support may further have a UV-shielding layer on the surface opposed to the surface having the organic-inorganic composite layer. The UV-shielding layer contains an appropriate binder and a UV-shielding material contained in the binder, and may have a monolayer structure or a layer of laminated plural layers. The UV-shielding material is at least one compound selected from a UV-absorbing agent and a UV-scattering agent. UV light impinging through the back of the support is effectively shielded by providing a layer containing these UV-shielding materials, and the support is suppressed from being deteriorated by the UV light.

Examples of the UV-absorbing agent may be the same as the weathering agent exemplified in the description of the above-mentioned UV-absorbing agent. The UV-absorbing agents may be used alone, or may be used in combination with the photostabilizer as needed.

The UV-scattering agent is a material that displays a UV-shielding effect by scattering UV light, and inorganic materials such as metal oxide powders are usually used. Examples of the UV-scattering agent include fine powders prepared by pulverizing titanium dioxide, zinc oxide or cerium oxide, hybrid inorganic powders prepared by compounding fine powders of titanium dioxide with iron oxide, or hybrid inorganic powders prepared by coating the surface of the fine particles of cerium oxide with non-crystalline silica. Since the UV scattering effect is largely affected by the particle diameter, the average particle diameter of the UV-absorbing agent is preferably 5 μm or less, particularly in the range of from 10 nm to 2 μm. When the UV-scattering agent has photocatalytic activity, the activity is preferably blocked by coating the surface of the particles with a thin film such as liquid glass.

The UV-shielding layer may have a monolayer structure containing at least one selected from the UV-absorbing agent and UV-scattering agent, or may have a laminated structure formed by laminating a plurality of layers of a layer containing the UV-absorbing agent and a layer containing the UV-scattering agent.

While the content of the UV-shielding material in the UV-shielding layer is not particularly restricted and may be appropriately selected depending on the kind of the UV-shielding material and the kind of the support, it is usually in the range of from 0.01 to 10% by mass, preferably from 0.05 to 5% by mass. When the UV-shielding material is the UV-shielding agent, the content is preferably in the range of from 0.1 to 10% by mass, particularly from 1 to 5% by mass. On the other hand, when the UV-shielding material is the UV-absorbing agent, the content is preferably in the range of from 0.01 to 10% by mass, particularly from 0.05 to 5% by mass.

The binder used for forming the UV-shielding layer is preferably an organic binder since an organic-inorganic composite layer is provided on the UV-shielding layer. The organic binder is not particularly restricted, and examples of the material of the binder include those known in the art such as acrylic resins, polyester resins, polyurethane resins and butyral resins as well as a cured product of UV curable resins.

The UV-shielding layer may be formed by preparing a coating liquid for the UV-shielding layer containing the binder and UV-shielding material, applying the coating liquid on the support using a known method such as a bar-coat method, knife coat method, roll coat method, blade coat method, die coat method or gravure coat method, and curing by heating or by irradiating UV light. The thickness of the UV-shielding layer is usually in the range of from 0.1 μm to 20 μm, preferably from 0.5 μm to 10 μm.

While the thickness of the support is not particularly restricted since it is appropriately determined by taking the mode of use of the photocatalyst film into consideration, it is preferably in the range of from 3 μm to 1 mm in terms of practical applicability, and in the range of from 10 μm to 300 μm in terms of flexibility and processability.

While the support as described above may be directly used when the support itself is able to generate active species by applying an energy, the surface of the support may have another surface layer having polymerization-initiating ability in order to more efficiently generate initiator species for forming the graft polymer chain. The surface layer having polymerization-initiating ability is preferably a layer containing a low molecular weight or high molecular weight polymerization initiator. The layer is preferably a polymerization initiating layer on which the polymerization initiator is immobilized by a crosslinking reaction in terms of stability and durability, more preferably a polymerization initiating layer prepared by immobilizing a polymer having functional groups having polymerization initiating ability and cross-linkable groups at the side chain by a crosslinking reaction. The polymerization initiating layer prepared by immobilizing the polymer having the functional group having polymerization initiating ability and cross-linkable group at the side chain by the crosslinking reaction is described in detail in paragraph numbers (0011) to (0169) of JP-A No. 2004-16199, and the polymerization initiating layer may be used in the invention.

### The Process for Forming the Organic-Inorganic Composite Layer

The organic-inorganic composite layer is formed in this process by hydrolysis and condensation polymerization of an alkoxide of an element selected from the group consisting of Si, Ti, Zr and Al in the graft polymer layer obtained in the above-mentioned process for forming the graft polymer layer.

That is, the organic component comprising the graft polymer chain and the crosslinked structure (sol-gel crosslinked structure) formed by the crosslinking reaction by hydrolysis and condensation polymerization of the alkoxide of the element selected from the group consisting of Si, Ti, Zr and Al are mixed in the organic-inorganic composite layer of the invention.

The sol-gel crosslinked structure of the invention is preferably formed using a compound capable of forming the crosslinked structure (hereinafter, may be simply referred to as a “crosslinking agent”) formed by applying the crosslinking reaction by hydrolysis and condensation polymerization of the element selected from the group consisting of Si, Ti, Zr and Al.

The cross linking agent applicable in the invention is a compound represented by the following formula (II).

The compound represented by the following formula (II) is able to form a covalent bond between the graft polymer chain and the sol-gel crosslinked structure by hydrolysis and condensation polymerization of the specific alkoxide group when the graft polymer chain contains the specific alkoxide group.

(R⁶)ₘ—X—(OR⁷)₄₋ₘ (II)

In formula (II), R⁶ represents a hydrogen atom, an alkyl group or an aryl group; R⁷ represents an alkyl group or an aryl group; X represents Si, Al, Ti or Zr; and m represents an integer of from 0 to 2.

When R⁶ and R⁷ represent alkyl groups, the carbon number thereof is preferably from 1 to 4. The alkyl group or aryl group may have a substituent, and examples of the substituent capable of being introduced include a halogen atom, an amino group and a mercapto group.

The compound is a low molecular weight compound preferably with a molecular weight of 1000 or less.

While specific examples of the compound represented by formula (II) are shown below, the invention is not restricted to these compounds. When X is Si, or when the hydrolyzable compound contains silicon in the hydrolyzable compound, examples of the compound include trimethoxy silane, triethoxy silane, tripropoxy silane, tetramethoxy silane, tetraethoxy silane, tetrapropoxy silane, methyltrimethoxy silane, ethyltriethoxy silane, propyltrimethoxy silane, methyltriethoxy silane, ethyltriethoxy silane, propyltriethoxy silane, dimethyldimethoxy silane, diethyldiethoxy silane, γ-chloropropyltriethoxy silane, γ-mercaptopropyltrimethoxy silane, γ-mercaptopropyltriethoxy silane, γ-aminopropyltriethoxy silane, phenyltrimethoxy silane, phenyltriethoxy silane, phenyltripropoxy silane, diphenyldimethoxy silane and diphenyldiethoxy silane. Tetramethoxy silane, tetraethoxy silane, methyltrimethoxy silane, ethyltrimethoxy silane, methyltriethoxy silane, ethyltriethoxy silane, dimethyldiethoxy silane, phenyltrimethoxy silane, phenyltriethoxy silane, diphenyldimethoxy silane and diphenyldiethoxy silane are particularly preferable examples among them.

When X is Al, or when the hydrolyzable compound contains aluminum, examples of the compound include trimethoxy aluminate, triethoxy aluminate, tripropoxy aluminate and tetraethoxy aluminate. When X is Ti, or when the compound contains Ti, examples of the compound include trimethoxy titanate, tetramethoxy titanate, trimethoxy titanate, tetraethoxy titanate, tetrapropoxy titanate, chlorotrimethoxy titanate, chlorotriethoxy titanate, ethyltrimethoxy titanate, methyltriethoxy titanate, ethyltriethoxy titanate, diethyldiethoxy titanate, phenyltrimethoxy titanate and phenyltriethoxy titanate. When X is Zr, or when the compound contains zirconium, examples of the compound are zirconates corresponding to the compounds exemplified as containing titanium.

For forming the sol-gel crosslinked structure in the graft polymer layer using the crosslinking agent as described above, the crosslinking agent is dissolved in a solvent such as ethanol, a coating liquid composition is prepared by optionally adding a catalyst to the solution prepared above, the composition is applied on the graft polymer layer, and the layer is dried with heating. The sol-gel crosslinked structure is formed by hydrolysis and condensation polymerization of the crosslinking agent. While the heating temperature and heating time are not particularly restricted so long as the temperature an time are enough for forming a tight coating film and are not particularly restricted, the heating temperature is preferably 200° C. or less while the heating time (crosslinking time) is preferably within 1 hour in terms of compatibility with production.

While the content of the cross linking agent in the coating liquid composition may be determined depending on the amount of the sol-gel crosslinked structure to be formed, the content is usually in the range of from 5 to 50% by mass, preferably from 10 to 40% by mass in terms of surface hardness and adhesiveness.

When the graft polymer chain contains the specific alkoxide group in the chain thereof, the content of the crosslinking agent in the coating liquid composition is preferably adjusted so that the cross-linkable group in the crosslinking agent is preferably 5 mol % or more, more preferably 10 mol % or more, relative to the amount of the specific alkoxide group. While the upper limit of the crosslinking agent is not particularly restricted so long as the amount is in the range sufficient for crosslinking with the specific alkoxide group, the organic-inorganic composite layer may become sticky due to the crosslinking agent not concerned in the crosslinking reaction when the crosslinking agent is added in large excess.

While the solvent used for preparing the coating liquid composition is not particularly restricted so long as it is able to homogeneously dissolve or disperse the crosslinking agent and other components, preferable examples of the solvent are aqueous solvents such as methanol, ethanol and water.

An acidic catalyst or a base catalyst is preferably used together in the coating liquid composition for enhancing hydrolysis and condensation polymerization of the crosslinking agent, and the catalyst is essential when practically preferable reaction efficiency is desirable. An acidic or a basic compound may be directly used for the catalyst, or the catalyst may be used by dissolving in water or alcohol (referred to an acid catalyst or a base catalyst, respectively, hereinafter). While the concentration of the catalyst dissolved in the solvent is not particularly restricted and may be appropriately selected depending on the property of the acid or basic compound and desired content of the catalyst, the hydrolysis rate and condensation rate tends to be increased when the concentration of the catalyst is high. However, since precipitates may be formed in the coating liquid composition when the base catalyst is used in a high concentration, the concentration is desirably 1 N or less as converted into an aqueous solution when the base catalyst is used.

While the kind of the acid catalyst or base catalyst is not particularly restricted, a catalyst composed of elements that do not remain in the coating film after drying is recommended when a high concentration of the catalyst is forced to use. Specific examples of the acid catalyst include hydrogen halide such as hydrochloric acid, nitric acid, sulfuric acid, sulfurous acid, hydrogen sulfide, perchloric acid, hydrogen peroxide, carboxylic acids such as carbonic acid, formic acid and acetic acid, substituted carboxylic acid prepared by substituting R in the formula represented by RCOOH with other elements or substituents, and sulfonic acids such as benzene sulfonic acid. Specific examples of the base catalyst include ammoniacal base such as aqueous ammonia and amines such as ethylamine and aniline.

Various additives may be used in the coating liquid composition in the range not impairing the effect of the invention. For example, a surfactant may be added for improving homogeneity of the coating liquid.

The graft polymer layer and organic-inorganic composite layer may be formed by the following method in the invention. The method comprises: preparing a coating liquid composition containing a polymer having functional groups reactive to the support at the terminal of the main chain or at the side chain, a crosslinking agent and a catalyst as well as the polar group and specific alkoxide group as described above; applying the coating liquid composition on the support on which radicals as active species are generated by treating the surface with plasma or electron beam; and drying the coating layer with heating.

In this method, a graft polymer directly bonded to the support is formed by allowing the functional group retained on the support and reactive to the support to react with the support, and the graft polymer layer is formed. It is also possible to form the crosslinked structure in the graft polymer layer by the hydrolysis and condensation polymerization of the crosslinking agent when the coating liquid composition is dried with heating. This means that the graft polymer layer and organic-inorganic composite layer may be formed at once according to this method by a series of processes comprising preparing the coating liquid composition and applying, heating and drying the liquid composition.

The coating liquid composition may further contain a hydrophilic polymer before preparing the composition. The hydrophilic polymer may be obtained by polymerization of monomers having useful polar groups for forming the above-mentioned graft polymer chain. The content of the hydrophilic polymer is preferably in the range of from 10% by mass or more to 50% by mass or less as converted into the content of the solid fraction. It is not preferable that the content is 50% by mass or more and less than 10% by mass, since the film strength may be decreased in the former case while the incidence of cracks is enhanced due to deterioration of the characteristics of the coating film in the latter case.

A sol-gel method is used for forming the organic-inorganic composite layer in the invention. The sol-gel method is described in “Science of Sol-Gel Method” by Sumio Sakuhana, published by Agne Shohuh Sha Co., 1988, and in “Latest Sol-Gel Metod” by Takashi Hirashima, published by Sogo Gijutsu Center, 1992, and the method described in these references may be applied for forming the organic-inorganic composite layer.

While the thickness of the organic-inorganic composite layer may be selected depending on the uses of the photocatalyst film, it is usually in the range of from 0.1 μm to 10 pm, more preferably from 0.5 μm to 10 μm. This range of thickness is preferable since the photocatalytic function may be sufficiently exhibited while curl of the film, decrease of flexibility and bendability hardly occur.

### The Process Forforming the Photocatalytically Active Layer

The photocatalytically active layer is formed on the organic-inorganic composite layer formed in the process for forming the organic-inorganic composite layer.

The photocatalytically active layer is a layer containing the photocatalytically active material. The photocatalytically active material capable of being contained in the photocatalytically active layer is not particularly restricted, and known photocatalytically active materials may be used. Specific examples of the photocatalytically active material include titanium dioxide, strontium titanate (SrTiO₃), barium titanate (BaTi₄O₉), sodium titanate (Na₂Ti₆O₃), zirconium dioxide, α-Fe₂O₃, tungsten oxide, K₄Nb₆O₁₇, Rb₄Nb₆O₁₇, K₂Rb₂Nb₆O₁₇, cadmium sulfide and zinc sulfide. Titanium dioxide, especially anatase type titanium dioxide, is useful as a photocatalytically active material for practical uses. This titanium dioxide displays excellent photocatalytic activity by absorbing a light of a specified wavelength in the UV region contained in sunlight.

One of the photocatalytically active material may be used alone or may be used as a combination thereof in the photocatalytically active layer. The content of the photocatalytically active material in the photocatalytically active layer is preferably in the range of from 1 to 100% by mass, more preferably from 20 to 100% by mass, relative to the total solid fraction contained in the photocatalytically active layer,

A known photocatalyst accelerating agent may be optionally added together with the photocatalytically active material in the photocatalytically active layer in order to facilitate the photocatalytic activity. Preferable examples of the photocatalyst accelerating agent include platinum group elements such as platinum, palladium, rhodium and ruthenium. One of these photocatalyst accelerating agents may be used alone, or a combination of a plurality of them may be used. The amount of addition of the photocatalyst accelerating agent in the photocatalytically active layer is selected in the range of from 1 to 20% by mass based on the total mass of the photocatalytically active material and photocatalyst accelerating agent on terms of photocatalytic activity.

The method for forming the photocatalyst accelerating layer in this process is not particularly restricted, and various methods may be used. For example, PVD methods (physical vapor deposition methods) such as a vacuum deposition method and sputtering method, dry methods such as a metal flame spray method, and a wet method using the coating liquid for forming the photocatalytically active layer containing the components of the photocatalytically active material may be used.

The metal flame spray method is favorably used when the dry method is applied since the apparatus and operation are simple. The photocatalytically active material is melted using a gas combustion flame in the metal flame spray method, and the material is sprayed onto the organic-inorganic composite layer as fine particles to form the photocatalytically active layer. When the photocatalyst accelerating agent and photocatalytically active material are used together for forming the photocatalytically active layer by applying the metal flame spray method, a mixture of the photocatalytically active material and photocatalyst accelerating agent is melted and sprayed onto the composite gradient layer, or the molten photocatalytically active material may be sprayed onto the organic-inorganic composite layer at first followed by spraying the molten photocatalyst accelerating agent.

For applying the dry method, a coating liquid for forming the photocatalytically active layer comprising a dispersion solution containing the photocatalytically active material and optionally used fine particles of the photocatalyst accelerating agent and inorganic binders in an appropriate solvent is prepared, and the photocatalytically active layer may be formed by applying the coating liquid on the organic-inorganic composite layer followed by spontaneous drying or heat-drying.

The content of the photocatalytically active material in the coating liquid for forming the photocatalytically active layer is preferably from 1 to 98% by mass, more preferably from 20 to 98% by mass, relative to the total solid fraction contained in the coating liquid.

Known methods may be used as the coating method of the coating liquid for forming the photocatalytically active layer, and examples of the method include dip coating method, spin coating method spray coating method, bar coating method, knife coating method, roll coating method, blade coating method, die coating method and gravure coating method.

The photocatalytically active layer may be formed by using, for example, the photocatalyst accelerating agent by the processes comprising: applying the coating liquid for forming the photocatalytically active layer containing the photocatalytically active material and optionally used fine powders of the inorganic binder on the organic-inorganic composite layer; immersing the support having a coating film of the photocatalytically active material formed on the organic-inorganic composite layer in an aqueous solution containing metal ions of the photocatalyst accelerating agent from which dissolved oxygen has been removed; and providing the photocatalyst accelerating layer on the coating film containing the photocatalytically active material by an optical deposition method by which the metal ions are deposited on the surface of the coating film by irradiating a light.

Any inorganic binders may be optionally used in the preparation of the coating liquid for forming the photocatalytically active layer so long as it is able to exhibit the function as a binder, and the binder is not particularly restricted. Examples of the binder include known binders such as oxides and hydroxides of silicon, aluminum, titanium, zirconium, magnesium, niobium, tungsten, tin and tantalum, or composite oxides and composite hydroxides of plural metals selected from the above-mentioned metals. One of the inorganic binders may be used, or a combination of a plurality of them may be used. The coating liquid may contain other known components of additives applicable to the coating liquid for forming the photocatalytically active layer, for example silicone resins and modified silicone resins and silane coupling agents.

The wet method is preferably used in the method fofororming the photocatalytically active layer in this process in terms of processability.

The thickness of the photocatalytically active layer is preferably in the range of from 10 nm to 5 μm, more preferably from 30 nm to 3 μm, and particularly from 40 nm to 1 μm in terms of exhibiting a sufficient photocatalytic function and suppressing the cracks from occurring and bendability from being decreased.

While the photocatalyst film of the invention comprises the organic-inorganic composite layer and photocatalytically active layer in this order on the support, other layers may be optionally provided. For example, an adhesive layer may be optionally provided on the surface of the photocatalyst film of the invention opposed to the surface having the photocatalytically active layer. The photocatalyst film of the invention may be readily bonded to an adhesion body by providing the adhesive layer. While the adhesive coated on the adhesive layer is not particularly restricted and may be appropriately selected for use from known adhesives, acrylic, urethane and silicone adhesives may be favorably used. The thickness of the adhesive layer is usually in the range of from 5 μm to 100 μm, preferably from 10 μm to 60 μm. The adhesive layer may optionally contain the weathering agent such as the UV absorbing agent and light stabilizing agent.

A release sheet may be optionally adhered on the adhesive layer. Examples of the release sheet include paper sheets such as glassine paper, coat paper and laminate paper, and various plastic film on which release agents such as silicone resin are coated. While the thickness of the release sheet is not particularly restricted, it is usually in the range about 20 pm to 150 μm. The surface of the adhesive layer is bonded to the adhering body after peeling the release sheet before use when the release sheet is provided as described above.

The photocatalyst film of the invention has antifouling, antibacterial and deodorizing functions, and may be used for various uses. For example, the film is provided on the body and window glass of automobiles and various transport facilities, buildings and window glasses thereof, traffic signs, roadside signboards, sound barriers of highways, convex mirrors at the roadside, and inside of frozen or refrigerated display cases in order to permit the effect for decomposing minute amount of harmful substances remaining on the surface or inner space to be displayer for a long period of time. The photocatalyst film may be also used as wrapping films for package of foods or for adhering on the inner surface of plastic vessels for storing drinking water.

### EXAMPLES

While the present invention is described with reference to examples below, the invention is by no means restricted to these examples.

### Example 1

### Preparation of Support A

Apolyethylene terephthalate (PET) film (trade name: TETRON HB, thickness; 3.50 pm, manufactured by Teijin DuPont Co.) in which a weathering agent was mixed by kneading was subjected to oxygen glow treatment using a planar magnetron sputtering apparatus (trade name: CFS-10-EP70, manufactured by Toshiba Eletec Co.) under the following conditions to obtain a PET support.

### (Oxygen Glow Treatment Conditions)

| | |
|---|---|
| Initial vacuum pressure: | 1.2 × 10⁻³ Pa |
| Oxygen pressure: | 0.9 Pa |
| RF glow: | 1.5 kW |
| Treatment time: | 60 sec |

### Preparation of Graft Polymer Layer 1

Nitrogen was bubbled in a mixed solution of N,N-dimethyl acrylamide, methacryloxypropyl triethoxysilane and ethanol (N,N-dimethyl acrylamide: methacryloxypropyl triethoxysilane=1:1 (molar ratio), concentration: 50% by mass). The above-mentioned PET support was immersed in this mixed solution for 7 hours at 70° C. The PET support after immersion was thoroughly washed with ethanol, and a graft polymer layer was formed, in which a graft polymer chain having a silane coupling group, serving as a specific alkoxide group, and an amide group in the structure thereof was directly bonded to the surface of the PET support. The PET support having this graft polymer layer is referred to as support A.

### Preparation of Organic-Inorganic Composite Layer 1

Coating liquid composition 1 containing ethanol, water, tetraethoxysilane and phosphoric acid in the following amount was stirred 24 hours at room temperature, and was applied on support A obtained above. An organic-inorganic composite layer was formed by drying the coating liquid composition 1 coated on support by heating at 100° C. for 10 minutes, whereby organic-inorganic hybrid film A was obtained.

### (Coating Liquid Composition 1)

| | |
|---|---|
| tetraethoxysilane (crosslinking component) | 0.9 g |
| ethanol | 3.7 g |
| water | 8.7 g |
| aqueous phosphoric acid solution (0.85% aqueous solution) | 1.3 g |

### Preparation of Photocatalytically Active Layer

Aphotocatalyst solution (trade name: ST-K211, manufactured by Ishihara Sangyo Co.) was applied on organic-inorganic hybrid film A obtained above, and heating was carried out at 120° C. for 10 minutes to form a photocatalytically active layer, whereby photocatalyst film A was obtained. The thickness of the photocatalytically active layer was 0.5 μm.

### Example 2

Photocatalyst film B was obtained by the same manner as in Example 1, except that the 0.9 g of tetraethoxysilane contained in coating liquid composition 1 used for forming the organic-inorganic composite layer in the preparation of organic-inorganic composite layer 1 in Example 1 was changed to 1.0 g of tetramethoxytitanate.

### Example 3

Photocatalyst film C was obtained by the same manner as in Example 1, except that the 0.9 g of tetraethoxysilane contained in coating liquid composition 1 used for forming the organic-inorganic composite layer in the preparation of organic-inorganic composite layer 1 in Example 1 was changed to 1.6 g of tetramethoxy zirconate.

### Example 4

Photocatalyst film D was obtained by the same manner as in Example 1, except that the 0.9 g of tetraethoxysilane contained in coating liquid composition 1 used for forming the organic-inorganic composite layer in the preparation of organic-inorganic composite layer 1 in Example 1 was changed to 0.7 g of tetramethoxy aluminate.

### Example 5

Support B was prepared by changing the preparation of graft polymer layer 1 in Example 1 to the preparation of graft polymer layer 2 described below. Photocatalyst film E was obtained by the same manner as in Example 1, except that organic-inorganic hybrid film B was prepared by changing support A used in the preparation of organic-inorganic composite layer 1 was changed to support B.

### Preparation of Graft Polymer Layer 2

Nitrogen was bubbled in an aqueous acrylamide solution (concentration: 50% by mass). The PET support used in Example 1 was immersed in this aqueous solution at 70° C. for 7 hours. The PET support after the immersion was thoroughly washed with distilled water, and a graft polymer layer having a structure in which the graft polymer chain having an amide group was directly bonded to the surface of the PET support was formed. The support having this graft polymer layer was used as support B.

### Example 6

### Preparation of Graft Polymer Layer 3

Nitrogen was bubbled in an ethanol solution of methacryloxypropyl triethoxysilane (concentration: 50% by mass). The PET support used in Example 1 was immersed in this solution for 7 hours at 70° C. The PET support after the immersion was thoroughly washed with distilled water to prepare a graft polymer layer having a structure in which a graft polymer chain having a silane coupling group as a specific alkoxide group was directly boded to the surface of the PET support. The support having this graft polymer layer was used as support C.

### Preparation of Organic-Inorganic Composite Layer 2

Coating liquid composition 2 containing 2-propanol, water, tetraethoxysilane and phosphoric acid in the following amounts was stirred for 5 hours at room temperature, and was applied on support C obtained above. An organic-inorganic composite layer was formed by drying the coating liquid composition 2 coated on support C by heating at 100° C. for 10 minutes, whereby organic-inorganic hybrid film C was obtained.

### (Coating Liquid Composition 2)

| | |
|---|---|
| 2-propanol | 8 g |
| tetraethoxysilane (crosslinking component) | 1.0 g |
| water | 1.0 g |
| aqueous phosphoric acid solution (0.85% aqueous solution) | 1.0 g |

### Preparation of Photocatalytically Active Layer

A photocatalytically active layer was formed on organic-inorganic hybrid film C obtained above by the same manner as forming the photocatalytically active layer in Example 1, whereby photocatalyst film F was obtained.

### Comparative Example 1

Support D was prepared by changing the preparation of graft polymer layer 1 in Example 1 to the preparation of graft polymer layer 4 described below. Photocatalyst film G was obtained by the same manner as in Example 1, except that the organic-inorganic composite layer 1 was not formed.

### Preparation of Graft Polymer Layer 4

Nitrogen was bubbles in a methylethyl ketone solution of styrene (concentration: 50% by mass). PET support used in Example 1 was immersed in this solution at 70° C. for 7 hours. The PET support after the immersion was thoroughly washed with methylethyl ketone, whereby support D having a surface grafted by styrene was obtained.

### Comparative Example 2

Photocatalyst film H was obtained by the same manner as in Example 1, except that support A used in Example 1 was changed to polyethylene terephthalate.

### Evaluation of Performance of Photocatalyst Film

Performance of each photocatalyst films A to G in Examples 1 to 6 and Comparative Examples 1 and 2 was evaluated by the following method. The results are shown in Table 1.

### 1. Evaluation of Adhesiveness

In accordance with JIS K5400 (2005 edition), one hundred of 1 mm squares was cut by using a rotary cutter on the photocatalytically active layer side of photocatalyst films A to G. Cellotape (trade name: manufactured by Nichiban Co.) was press-bonded onto the photocatalyst films, and then was peeled at a rate of 30,000 mm/min at an angle of 90°. This peeling test was repeated three times. The results were evaluated by counting the number of the squares remaining after the peeling test. The results are shown in Table 1.

### 2. Weather Resistance

Photocatalyst films A to G were subjected to an accelerated weathering test for 900 hours using a carbon arc sunshine weather meter (trade name: WEL-SUN-HCT, manufactured by Suga Test Machine Co.). The contact angle of water on the film was measured, and incidence of interference, if any, was visually investigated. The results are shown in Table 1.

### 3. Bendability

Photocatalyst films Ato G cut into a width of 4 cm were wound 1 turn around a stainless steel rod with a diameter of 2 mm so that the photocatalytically active layer is exposed outside for 2R bending test. The bent portion was observed under a surface configuration measuring microscope (trade name: VF-7500, manufactured by Keyence Co.) with a magnification of 2,500, and incidence of linear cracks and peeling, if any, were investigated. The results are shown in Table 1.

TABLE 1

| | | | Weather resistance | | Bendability |
|---|---|---|---|---|---|
| | Photocatalyst | | | Contact angle | (2R bending |
| | film | Adhesiveness | Interference | of water | test) |
| Example 1 | Photocatalyst | 100/100 | None | <3 | No problem |
| | film A | | | | |
| Example 2 | Photocatalyst | 100/100 | None | <3 | No problem |
| | film B | | | | |
| Example 3 | Photocatalyst | 100/100 | None | <3 | No problem |
| | film C | | | | |
| Example 4 | Photocatalyst | 100/100 | None | <3 | No problem |
| | film D | | | | |
| Example 5 | Photocatalyst | 100/100 | None | <3 | No problem |
| | film E | | | | |
| Example 6 | Photocatalyst | 100/100 | None | <3 | No problem |
| | film F | | | | |
| Comparative | Photocatalyst | 100/100 | Presence | <3 | Incidence of |
| example 1 | film G | | | | cracks |
| Comparative | Photocatalyst | 5/100 | None | <3 | Incidence of |
| example 2 | film H | | | | cracks |

The results in Table 1 show that photocatalyst films A to F having the organic-inorganic composite layer are excellent in adhesiveness between the support and the photocatalytically active layer and in good weather resistance, and therefore have high durability against deterioration caused by photocatalytic action. It was also shown that the photocatalyst films A to F are excellent in bendability.

On the other hand, photocatalyst film G of Comparative Example 1, which has a photocatalytically active layer directly formed on the graft polymer layer formed on the support without forming the organic-inorganic composite layer, exhibited low weather resistance and poor bendability, although adhesiveness between the support and the photocatalytically active layer was satisfactory. Photocatalyst film H of Comparative Example 2 having the photocatalytically active layer directly formed on the support exhibited low adhesiveness between the support and the photocatalytically active layer and was poor in bendability.

Accordingly, the invention provides a photocatalyst film having high adhesiveness between the photocatalytically active layer and the support and good durability against deterioration caused by the photocatalytic action with persistence of durability.

All publications, patent applications, and technical standards mentioned in this specification are herein incorporated by reference to the same extant as if each individual publication, patent application, or technical standard was specifically and individually indicated to be incorporated by reference.

What is claimed is:

1. A photocatalyst film comprising, in the following order:
a support;
an organic-inorganic composite layer containing, in a graft polymer layer comprising a graft polymer chain directly bonded to the surface of the support, a crosslinked structure formed by hydrolysis and condensation polymerization of an alkoxide of an element selected from the group consisting of Si, Ti, Zr and Al; and
a photocatalytically active layer.

2. The photocatalyst film according to claim 1, wherein the graft polymer chain has an alkoxide group of an element selected from the group consisting of Si, Ti, Zr and Al in the chain thereof.

3. The photocatalyst film according to claim 2, wherein the alkoxide group is a group represented by the following formula (I):
(R¹)ₘ(OR²)₃₋ₘ—Si— (I)
wherein, in formula (I), R¹ and R² each independently represent a hydrogen atom or a hydrocarbon group having 8 or less carbon atoms; and m represents an integer of from 0 to 2.

4. The photocatalyst film according to claim 1, wherein the graft polymer chain has an amide group in the chain thereof.

5. The photocatalyst film according to claim 4, wherein an amount of introduction of the amide group in the graft polymer chain is in the range of from 10 mol % to 90 mol %.

6. The photocatalyst film according to claim 1, wherein the graft polymer chain is a copolymer having a structural unit having an amide group and a structural unit having an alkoxide group of an element selected from the group consisting of Si, Ti, Zr and Al.

7. The photocatalyst film according to claim 6, wherein the alkoxide group is a group represented by the following formula (I):
(R¹)ₘ(OR²)₃₋ₘ—Si— (I)
wherein, in formula (I), R¹ and R² each independently represent a hydrogen atom or a hydrocarbon group having 8 or less carbon atoms; and m represents an integer of from 0 to 2.

8. The photocatalyst film according to claim 1, wherein the thickness of the organic-inorganic composite layer is in the range of from 0.1 μm to 10 μm.

9. The photocatalyst film according to claim 1, wherein the thickness of the photocatalytically active layer is in the range of from 10 nm to 5 μm.

10. The photocatalyst film according to claim 1, wherein the support contains a weathering agent.

11. The photocatalyst film according to claim 1, wherein the support is flexible.

12. The photocatalyst film according to claim 1, wherein the support is a transparent support.

13. A method for manufacturing a photocatalyst film comprising:
forming a graft polymer layer comprising a graft polymer chain by forming the graft polymer chain directly bonded to the surface of a support;
forming an organic-inorganic composite layer by a crosslinking reaction including hydrolysis and condensation polymerization of an alkoxide of an element selected from the group consisting of Si, Ti, Zr and Al in the graft polymer layer; and
forming a photocatalytically active layer on the organic-inorganic composite layer.

14. The method for manufacturing a photocatalyst film according to claim 13, wherein the graft polymer chain is a graft polymer chain formed by using a monomer or macromer having an alkoxide group of an element selected from the group consisting of Si, Ti, Zr and Al.

15. The method for manufacturing a photocatalyst film according to claim 14, wherein the alkoxide group is a group represented by the following formula (I):
(R¹)ₘ(OR²)₃₋ₘ—Si— (I)
wherein, in formula (I), R¹ and R² each independently represent a hydrogen atom or a hydrocarbon group having 8 or less carbon atoms; and m represents an integer of from 0 to 2.

16. The method for manufacturing a photocatalyst film according to claim 13, wherein the graft polymer chain is a graft polymer chain formed by using a monomer or macromer having an amide group.

17. The method for manufacturing a photocatalyst film according to claim 13, wherein the graft polymer chain is formed by a copolymerization of a monomer having an amide group and a monomer having an alkoxide group of an element selected from the group consisting of Si, Ti, Zr and Al.

18. The method for manufacturing a photocatalyst film according to claim 13, wherein the crosslinking reaction is a reaction by hydrolysis and condensation polymerization of the alkoxide of the element selected from the group consisting of Si, Ti, Zr and Al contained in the graft polymer layer and a crosslinking agent.

19. The method for manufacturing a photocatalyst film according to claim 18, wherein the crosslinking agent is a compound represented by the following formula (II):
(R⁶)ₘ—X—(OR⁷)₄₋ₘ (II)
wherein, in formula (II), R⁶ represents a hydrogen atom, an alkyl group or an aryl group; R⁷ represents an alkyl group or an aryl group; X represents Si, Al, Ti or Zr; and m represents an integer of from 0 to 2.
